(19) United States
(12) Patent Application Publication
(10) Pub. No.: US 2017/0093779 A1
(43) Pub. Date: Mar. 30, 2017

(54) INCORPORATING DYNAMIC CONTENT IN MESSAGING APPLICATIONS

(71) Applicant: Whiteboard Applications, Inc., Vienna, VA (US)

(72) Inventors: David T. TALIAFERRO, Leesburg, VA (US); Charles Lee SWISHER, III, Fairfax, VA (US)

(21) Appl. No.: 15/202,458

(22) Filed: Jul. 5, 2016

Related U.S. Application Data
(60) Provisional application No. 62/189,185, filed on Jul. 6, 2015.

(51) Int. Cl. H04L 12/58; H04L 29/08

(52) U.S. Cl. CPC H04L 51/18; H04L 51/04; H04L 67/20

(57) ABSTRACT

A method of operating a sending device to send dynamic content to a receiving device. The method includes determining a third party server based on input from a user; sending a request to the third party server for the dynamic content, the request including at least one parameter associated with the dynamic content; receiving the dynamic content from the third party server, the dynamic content being based on the at least one parameter; displaying the dynamic content on a visual display of the sending device; receiving an indication from the user of the sending device to send the dynamic content to the receiving device; and sending a message to the receiving device, the message including the at least one parameter associated with the dynamic content. The message itself does not include the dynamic content.

### CROSS-REFERENCE TO RELATED APPLICATIONS

This application claims the benefit of U.S. Provisional Application No. 62/189,185, filed Jul. 6, 2015, entitled “INCORPORATING LIVE CONTENT IN MESSAGING APPLICATIONS”, which is incorporated by reference herein in its entirety for all purposes.

### BACKGROUND

Messaging applications, in both conventional computing environments, such as desktops and laptops, and mobile environments, take advantage of computer networks to connect users to one another in a more immediate way than email systems while using less of a user's attention than a phone call. Unlike email systems where a message is sent without knowing if the other user is available to receive the sent message, messaging applications typically indicate whether the user is available to participate in a messaging conversation and/or indicate that a user has received or read a message. While the sent message is typically received in real time by the recipient, the receiving and responding to the message does not require the recipient's complete attention the way receiving a phone call would. Instead, the recipient can review the received message and consider the reply prior to responding. Moreover, as compared to phone calls, messaging applications keep a record of the conversation a sender has with a recipient and allows the conversation to be resumed at any time. Additionally, phone calls do not allow text, images, audio, video or other rich content to be shared between a sender and a recipient.

Email is considered too slow and unresponsive while placing a phone call is considered too intrusive. Accordingly, messaging applications (e.g., Apple's iMessage, short message service (SMS) clients, WhatsApp, Skype, etc.) are becoming the preferred way of communicating with friends, family and colleagues.

Conversations that occur within messaging applications can be one-to-one conversations between one sender and one recipient. Alternatively, a conversation may be between more than two users such that each user of a “group chat” receives the message from each other user that sends a message to the group chat.

### SUMMARY

An example of a method of operating a sending device to send dynamic content to a receiving device includes: determining a third party server based on input from a user; sending a request to the third party server for the dynamic content, the request comprising at least one parameter associated with the dynamic content; receiving the dynamic content from the third party server, the dynamic content being based on the at least one parameter; displaying the dynamic content on a visual display of the sending device; receiving an indication from the user of the sending device to send the dynamic content to the receiving device; and sending a message to the receiving device, the message comprising the at least one parameter associated with the dynamic content, wherein the message does not include the dynamic content.

Implementations of such a method may also, or alternatively, include one or more of the following features. The method may include receiving an indication of the at least one parameter from the user of the sending device. Sending the request and displaying the dynamic content may be performed by a messaging application executing on the sending device. The message may include an expected refresh frequency indicating how frequently the receiving device is expected to request updated content. Sending the message to the receiving device may include sending the message to a messaging server that stores the message on behalf of the receiving device. The message may additionally include plaintext to be displayed to a recipient of the message. The at least one parameter may include an identification of the third party server based on the input from the user.

An example non-transitory processor-readable storage medium includes processor-readable instructions configured to cause a processor of a sending device to: determine a third party server based on input from a user; send a request to the third party server for dynamic content, the request comprising at least one parameter associated with the dynamic content; receive the dynamic content from the third party server, the dynamic content being based on the at least one parameter; display the dynamic content on a visual display of the sending device; receive an indication from the user of the sending device to send the dynamic content to the receiving device; and send a message to the receiving device, the message comprising the at least one parameter associated with the dynamic content, wherein the message does not include the dynamic content.

Implementations of such a method may also, or alternatively, include one or more of the following features. The instructions may be further configured to cause the processor to receive an indication of the at least one parameter from the user of the sending device. The instructions may be a portion of a messaging application. The message may include an expected refresh frequency indicating how frequently the receiving device is expected to request updated content. The instructions may be further configured to cause the processor to send the message to a messaging server that stores the message on behalf of the receiving device. The message may include plaintext to be displayed to a recipient of the message. The at least one parameter may include an identification of the third party server based on the input from the user.

An example of a sending device includes: a network interface configured to send and receive messages from a network; a processor, communicatively coupled to the network interface, configured to: determine a third party server based on input from a user; send, via the network interface, a request to the third party server for dynamic content, the request comprising at least one parameter associated with the dynamic content; receive, via the network interface, the dynamic content from the third party server, the dynamic content being based on the at least one parameter; a visual display, communicatively coupled to the processor, configured to display the dynamic content; and a user input device, communicatively coupled to the processor, configured to receive an indication from the user of the sending device to send the dynamic content to the receiving device. The processor is further configured to send a message to the receiving device, the message comprising the at least one parameter associated with the dynamic content, wherein the message does not include the dynamic content.

Implementations of such a method may also, or alternatively, include one or more of the following features. The user input device may be configured to receive an indication of the at least one parameter from the user of the sending device. The processor may be configured to send the request and control the visual display to display the content by executing a messaging application. The message may include an expected refresh frequency indicating how frequently the receiving device is expected to request an updated content. To send the message to the receiving device the processor may be configured to send the message to a messaging server that stores the message on behalf of the receiving device. The message may include plaintext to be displayed to a recipient of the message.

The foregoing is a non-limiting summary, which is defined by the attached claims. Items and/or techniques described herein may provide one or more of the following capabilities, as well as other capabilities not mentioned. Users of mobile devices can receive real-time, up-to-date information in their messaging applications without the need to switch between applications. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a networking environment including mobile devices, computing devices, a messaging server and a third party server.

FIG. 2 is a sending device and a receiving device executing a messaging application.

FIG. 3 is a messaging sequence diagram.

FIG. 4 is a flow diagram of a method of operating a sending device.

FIG. 5 is a flow diagram of a method of operating a receiving device.

FIG. 6 is a computing environment.

### DETAILED DESCRIPTION

The inventors have recognized and appreciated that, while messaging applications are capable of sharing static content well, there is a need for a messaging application that is capable of sharing dynamic content (sometimes referred to as “live content” or “real-time content”). Dynamic content is content that changes as time progresses. Non-limiting examples of dynamic content include flight information (e.g., when a particular flight will arrive at its destination or depart from its origin), train information, weather information, the score of a particular sports game, the price of a product for sale, news headlines, business enterprise information (e.g., the status or alarm associated with an industrial or enterprise management system), Twitter feeds of particular users, and the current location of a person and/or device. Dynamic content may be obtained over a computer network, such as the Internet, by accessing servers, which may be operated by third parties unaffiliated with providing the messaging service accessed via the messaging application. Dynamic content may also include information from the sender's computing device—such as the current location and/or velocity of that device.

Using a conventional messaging application, users can attach static content along with their messages (pictures, links, voice clips, etc.). If the content a user wishes to share is on a website or inside a different application, the user either has to copy and paste the information, retype it or take a screen shot. This may require the user of a mobile device to do a significant amount of “app flipping,” wherein the user is required to switch between the messaging application and the application that displays the content (e.g., a web browser or a purpose-built application, such as a Twitter client) in order to retrieve the desired content and include it in a message. Moreover, if the content pasted into a message changes, the content included in the message will become quickly outdated. Even if the content is pasted into a message as a link, additional steps are required by the recipient to determine whether the content at the website has changed and to obtain the most up to date content. To ensure the receiving user has the most up to date information, they are then required to go to retrieve the up to date information themselves using an application such as a web browser or a purpose-built application.

Embodiments described herein may reduce the amount of app flipping required to include information in a message. Some embodiments include a messaging application. Such a messaging application may include components executed at a client device initiating a message and/or at a client device receiving and displaying a message. A messaging application executing on a user's computing device may be configured to send or receive messages with dynamic content, and may be configured to both send and receive messages with dynamic content such that two or more users in a conversation may all send and receive dynamic content. The components of the messaging application on the sending device may receive input from the sending user specifying the dynamic content to be included in the message. On the receiving device, the components of the messaging application may access the specification of dynamic content in a message in response to one or more trigger events, access the dynamic content from an external source and integrate it into a message as presented to the receiving user.

The above functions may be achieved by including an interface within the messaging application that gives a user easy access to dynamic content. Moreover, problems with content included in messages becoming outdated may be overcome by, rather than including the content itself in a message, including parameters associated with the content such that the content may be retrieved by the receiving user's device at a later time without intervention by either the sender or recipient. The sending and receiving user's devices may exchange these parameters and, based on these parameters, retrieve the dynamic content using one or more application programming interfaces (APIs) that obtain content from third party servers associated with the dynamic content.

By way of example and not limitation, the parameters of the dynamic content input by the sending user may include an identification of an API and parameters that are passed through that API to obtain specific dynamic content. As a specific example, if a sender wishes to send to a recipient information about when her flight lands, the sender may select “flight information” from a graphical user interface. This input value may identify an API to a third party server that supplies flight information. The user also may input the airline, date, and the flight number to the messaging application.

The messaging application may display the dynamic content in place of the identified API and other parameters. The messaging application then, using the third party API, communicates these flight parameters to a third party server that hosts the flight information. The flight information may then be displayed on the sender's device.

The sender's device may communicate the parameters used by the API to the recipient's device. The recipient's device may then use the parameters to retrieve the dynamic content from the third party server. The recipient's device may retrieve the dynamic content at a subsequent time without intervention by either the sender or the recipient. Thus, if the time the sender's flight landing time changes, e.g., due to a delay, the recipient's device will retrieve this updated dynamic content rather than the content that existed at the time the message was originally sent by the sender. In this way, the recipient will have access to the most up to date information from within the messaging application itself, without needing to follow a link to a web browser or some other purpose-built application.

The messaging application (on the sender's device and/or receiver's device) may retrieve the current dynamic content in response to one or more trigger events. These non-limiting trigger events may include periodic refresh of the dynamic content as specified by the user, push notifications from external third party systems (e.g., third party servers associated with an API), displaying the message with the dynamic content, displaying another message in a conversation containing the message with dynamic content or some other user interaction with the device, such as scrolling through a chain of messages representing the conversation. In some embodiments, when the recipient's device receives dynamic content, the messaging application may trigger additional events. For example, if the recipient's device receives dynamic content associated with the status of some industrial or enterprise management system, the messaging application may open a separate application for controlling that industrial or enterprise management system on the recipient's device. Additionally, rather than triggering additional events at the time the dynamic content is received, additional events may be triggered when the dynamic content satisfies some condition that may be set by the sender, the receiver, or the third party operating the third party server. For example, if the dynamic content contains status information about an alarm or a measurement value of an industrial or enterprise management system, the additional event (e.g., opening a different application on the recipient's device) may only be triggered when the alarm enters an alarm state or when the measurement value reaches a predetermined value or exceeds a predetermined threshold. By automatically triggering this additional event (e.g., opening a different application), the recipient of the dynamic content may take immediate action with regards to the event that triggered the additional event.

Some embodiments are directed to a computing device that includes a non-transitory storage device that stores instructions, that when executed by a processor of the computing device executes a messaging application method. The method includes receiving input from a user specifying one or more parameters associated with dynamic content, which is content that is subject to change based on real-world physical or virtual events; invoking an API to create an API request that includes one or more parameters entered by the user; sending the API request to a third party server associated with the dynamic content; receiving the dynamic content from the third party server; and displaying the dynamic content in a messaging window of the messaging application.

Some embodiments are directed to a method of sending dynamic content from a sender to a recipient within a messaging application. The method includes receiving input from a sender specifying one or more parameters associated with dynamic content; sending the parameters associated with the dynamic content to the recipient in a message within the messaging application; at the recipient's device, receiving the parameters associated with the dynamic content; invoking an API to create an API request that includes the parameters; sending the API request to a third party server associated with the dynamic content; receiving the dynamic content from the third party server; and displaying the dynamic content in a messaging window of the messaging application, wherein the messaging window displays messages from the sender.

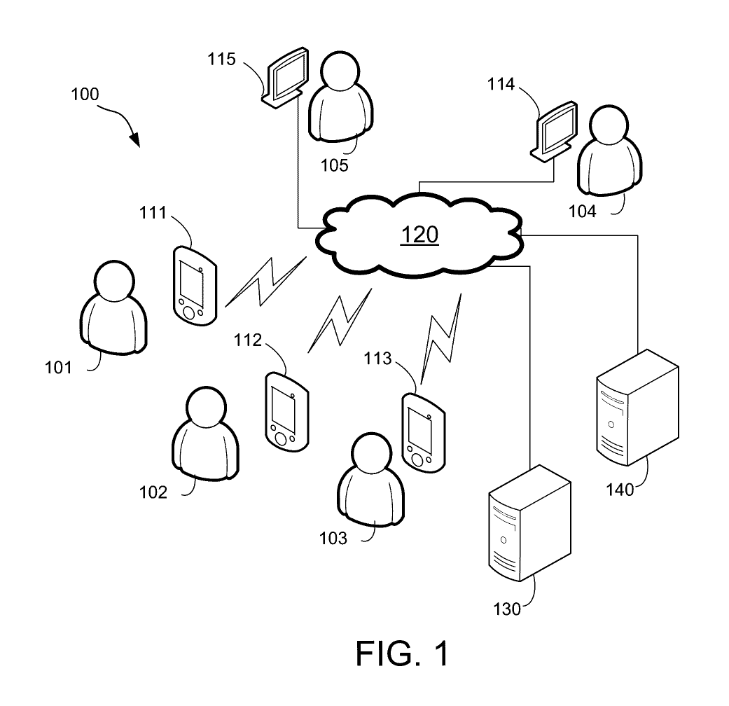

Referring to FIG. 1, a networking environment 100 that includes the above-mentioned sending device 111 and receiving device 112 is shown. A plurality of users 101-105 communicate with one another via computing devices 111-115, which include sending device 111 and receiving device 112. Any suitable computing device may be used by the users. By way of example and not limitation, the computing device may be a mobile telephone, a personal digital assistant, a tablet, a smart watch, a laptop computer, or a desktop computer. FIG. 1 illustrates three mobile telephones 111-113 as the computing devices for users 101-103 and two desktop computers 114-115 as the computing devices for users 104-105. The mobile telephones 111-113 connect to a network 120 via wireless communications technology. For example, the mobile telephones 111-113 may communicate with a wireless router connected to the network 120 using a wireless internet protocol or the mobile telephones 111-113 may communicate with a cellular network base station using a cellular telephone communications protocol. The network 120 may include a local area network and/or the Internet.

In some embodiments, each computing device 111-115 includes at least one processor for executing a messaging application with the ability to send messages and other information to the other devices 111-115 connected to network 120. The messaging application may send text messages as well as other information such as photographs, videos, emoticons, audio files and information from embedded device sensors (e.g., position, altitude, device orientation, speed, etc.). The users 101-105 of the computing devices 111-115 may be a sender of a message and/or a recipient of a message. A sender may send a message to a single recipient or plurality of recipients.

The computing devices 111-115 may communicate with each other via a messaging server 130 operated by or on behalf of the entity that provides the messaging application to the users. For example, a message sent from sender's device 111 to recipient's device 112 may travel on the network 120 to the messaging server 130 where the message may be processed. Processing of the message may include storing copies of the messages and/or storing metadata about the message. For example, the message may be placed in a queue of messages designated to be delivered to the recipient's device 112. The message may then be sent from the server messaging 130 to the recipient's device 112. The message may be sent to the recipient's device 112 in response to a request sent to the messaging server 130 from the recipient's device 112, or the message may be “pushed” from the messaging server 130 to the recipient's device 112 in the absence of a request. Implementations are not limited to using a messaging server 130. The message may be directly sent from the sender's device 111 to the recipient's device 112 without first being stored at the messaging server 130.

When a sender of a message wishes to include dynamic content in a message, the sender can access a menu of available dynamic content in a graphical user interface (GUI) of the messaging application. For example, a scrollable ribbon that displays icons associated with dynamic content may be displayed in the messaging application's GUI. There may be, for example, an icon for flight information, product sales information, location information or other dynamic content. When a user selects an icon, the user may be prompted for additional information, such as a flight number, a name of a product for sale, or other parameters that may be used to retrieve the dynamic content from a third party server.

Alternatively or additionally, the user may include dynamic content in a message by using a smart tag in the text of a message. For example, the messaging application may interpret certain symbols as being part of a smart tag that results in the calling of an API to retrieve dynamic content from the third party server. By way of example and not limitation, information include in square brackets may be interpreted as a smart tag such that if a user types “[FLIGHT AA276, Arrival, 6/30]”, the messaging application interprets as a request to include dynamic content about the arrival time of American Airlines flight 276 on June 30^{th} of the present year. One of skill in the art should understand that various character or combination of characters may also be used to identify that the information is contained in a smart tag. For example, the smart tag may be initiated using the hash symbol, such as “#FLIGHT (AA276, Arrival, 6/30)”. The parameters that are included in a smart tag vary depending on the type of dynamic content being included in a message. For example, for flight information, the flight number and date may be included, as well as whether the user desires arrival time or departure time. Alternatively, if the dynamic content is product information, the parameter may only include a product identification number. For example, if the product is for sale on Ebay or Amazon, the product identification number is the identifier used by the website to uniquely identify the product that is for sale.

Additionally, the text of a message entered by the user of a sending device may be interpreted using natural language processing to determine if the user is attempting to include dynamic content in the message being sent. For example, if the sender enters the text, “I am on flight AA276 which arrives on June 30^{th},” then the messaging application may automatically identify that there is dynamic content associated with this message and include the dynamic content in the message. Regardless of the manner in which the dynamic content is specified by the sending user, the messaging application may insert into the message sufficient information to enable the messaging application at the receiving user's device to identify a server or other network location from which that dynamic content may be obtained as well as other parameters that, when supplied to that network location, result in a current version of the specified content being returned to the receiving device.

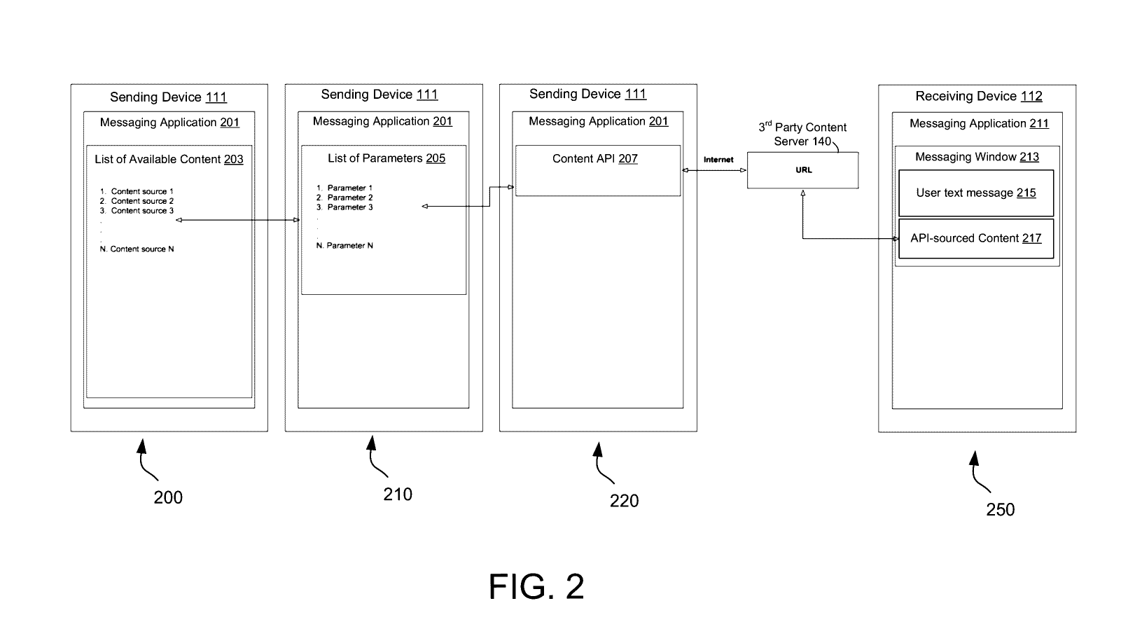

Referring to FIG. 2 the operation of a messaging application is shown. A sending device 111 of a sender 101 executes the messaging application 201. Within the messaging application 201, a list of available dynamic content 203 is displayed to the sender, as shown in screenshot 200. The list of available dynamic content 203 is a list of sources of dynamic content from which the sender 101 can select a source. Each source listed in list of available dynamic content 203 may be associated with an API for retrieving the content from a third party server that acts as the source of the dynamic content. For example, flight information may be obtained from a first source, product information may be obtained from a second source, sports and sports scores may be obtained from a third source. Each source may also be associated with its own uniform resource locator (URL) via which the API connects to the third party server.

When the sender selects a source from the list of available content 203, the messaging application 201 displays a list of parameters 205 to the sender, as illustrated in screenshot 210. The sender may select parameters from a list of optional parameters and/or the list of parameters 205 may include a form that allows the sender to type parameter information into the messaging application. For example, the messaging application 201 may request a flight number be entered by the user using a keyboard, a touchscreen, or other input device of the sender's device 111.

As illustrated in screenshot 220, after the sender enters the parameters associated with the dynamic content, the content API 207 receives the parameters from the messaging application 201 and communicates the parameters to the third party content server 140 associated with the content source selected from the list of available content 203. The API may send packets of information using a URL associated with dynamic content requests on the third party content server 140.

The text message and the selected dynamic content API parameters are sent to the recipient(s) of the sender's message. The recipient's device 112 (and any other device that receives the message) executes a messaging application 211 with a messaging window 213 for displaying text message 215 and API-sourced dynamic content 217. The dynamic content 217 is retrieved from the third party content server 140 using the same content API used by the sender's device 111 and the same URL. The recipient's API uses the parameters sent from the sender's device 111 in its request for dynamic content. When the recipient's device 112 receives the dynamic content from the third party content server 140, it is displayed to the recipient. The dynamic content may be displayed “inline” with the text of the text message, or may be displayed in a separate display window within the messaging window 213, as illustrated in screenshot 250.

The sender's device 111 may also retrieve the dynamic content from the third party content server 140 in the same way as the recipient's device 112. In this way, the dynamic content may be displayed to the sender in the same way that it is displayed to the recipient via the recipient's device 112. The sender's device 111 may send the API parameters associated with the dynamic content to the recipient before, after, or while the dynamic content is being retrieved from the third party content server 140. If the dynamic content is retrieved prior to sending the dynamic content parameter's to the recipient's device, the sender can review the dynamic content and confirm that it is the content she wished to include in the message prior to sending the message to the recipient.

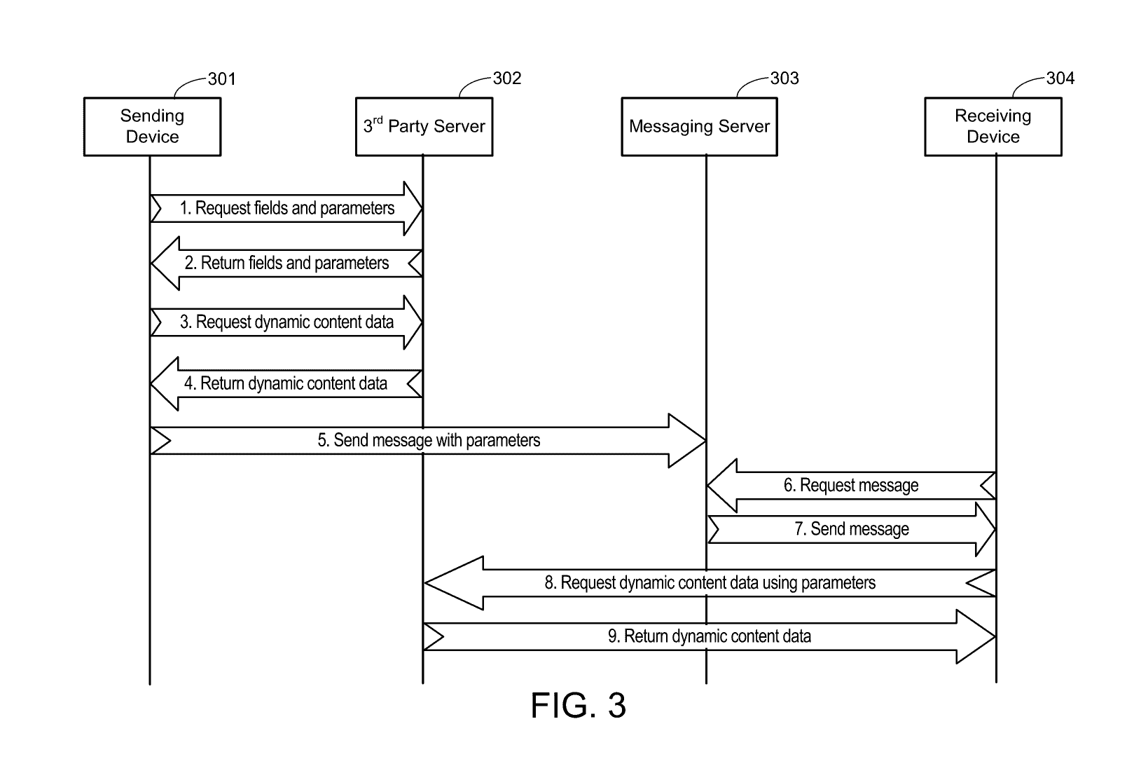

Referring to FIG. 3, the various information sent between a sending device 301, a third party server 302, a messaging server, and a receiving device 304 is illustrated. At step 1, the sending device sends a request for fields and parameters associated with the API of the third party server 302 to the third party server 302. The fields are the options that the user of the sending device 301 can use when selecting dynamic content in the messaging application. The parameters are the values the fields can have. For example, the fields may include “airline name. The parameters for the field “airline name” may include “Jet Blue” and “United.” Other fields may not have pre-selected options for parameters. For example, the fields may include “flight number” and/or “flight time.” These parameters may be provided manually by the user of the sending device, as described below.

Step 1 may be performed at a time prior to the user of the sending device sending a message that includes dynamic content. For example, step 1 may be performed the first time the messaging application is executed by the sending device 301. Alternatively, step 1 may be omitted in situations where the messaging application already includes the fields and parameters associated with the API of the third party server 302.

At step 2, the third party server 302 returns the fields and parameters associated with the API. If step 1 is omitted, then step 2 is also omitted.

At step 3, the sending device 301 sends a request for dynamic content data to the third party server 302. This occurs after the user of the sending device 301 has selected the dynamic content source and parameters, as discussed in connection with FIG. 2. The request for the dynamic content data includes the parameters selected by the user of the sending device 301 from within the messaging application. The user may provide indications of the parameters using an input device of the sending device 301, such as a mouse, a keyboard or a touch screen.

At step 4, the third party server 302 returns the requested dynamic content data to the sending device 301. This allows the user of the sending device 301 to verify the information is what the user wishes to send to the recipient.

At step 5, the sending device 301 sends a message that includes the parameters, but does not include the dynamic content, to the messaging server 303. The message may also include text information to be displayed to the recipient. The messaging server 303 is operated by or on behalf of the entity that provides the messaging application to the users. The messaging server 303 holds pending messages in a queue until the intended recipient is able to receive the pending messages. While not shown here, it is possible for the messaging application to be a peer-to-peer messaging application that does not use the messaging server 303. In such implementations, the message may be sent from the sending device 301 to the receiving device 304.

At step 6, the receiving device 304 requests the message from the messaging server 303. The request may be sent in response to a trigger event occurring. The trigger event may include the messaging application being opened on the receiving device 304. Alternatively or additionally, the request may be sent after a period of time. For example, the messaging application executing on the receiving device 304 may send a request for pending messages every 30 seconds, minute, two minutes or five minutes.

In some implementations, an explicit request need not be sent. For example, the messaging application of the receiving device 304 can send a status to the messaging server, the status indicating that the user of the receiving device 304 is currently available. The messaging server 303 can send pending messages to the receiving device 304 when the user has an available status.

At step 7, the messaging server 303 sends the message to the receiving device 304. The message includes the parameters selected by the user of the sending device, but need not include the dynamic content. The receiving device 304 can parse the message from the messaging server 303 to determine if the message includes parameters associated with dynamic content.

At step 8, in response to determining that the message includes parameters associated with dynamic content, the receiving device 304 sends a request for the dynamic content data. The request includes the parameters that were received in the message from the sending device 301.

At step 9, the messaging server 303 returns the dynamic content data to the receiving device 304. The specific content data sent from the messaging server 303 to the receiving device 304 may be different from the content data sent to the sending device 301 at step 4. This is because the dynamic content data is real-time, live content that may be constantly changing. The third party server 302 returns the dynamic content as it exists at the time the content data is sent.

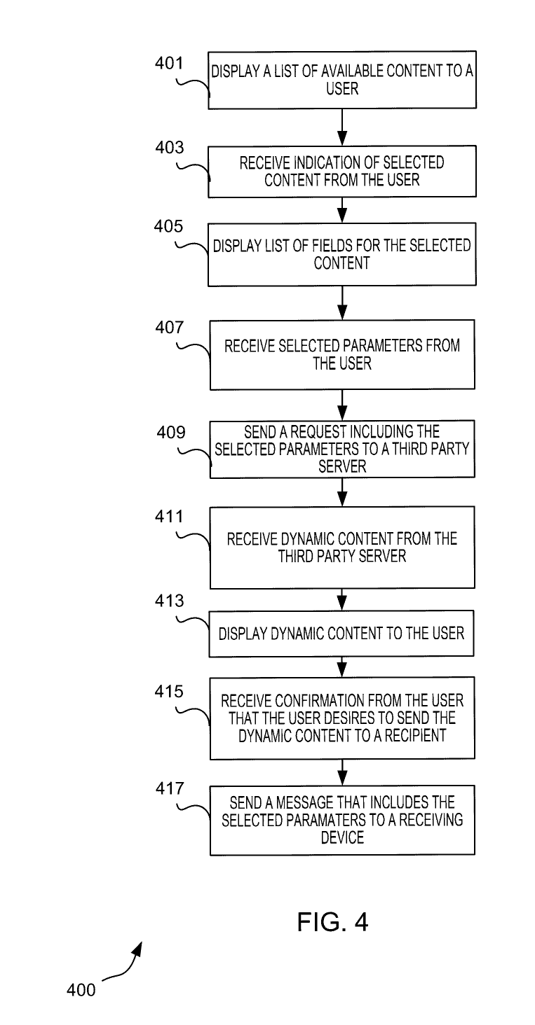

Referring to FIG. 4, a method 400 of operating the sending device 301 includes the acts shown. The method 400 is, however, an example only and not limiting. The method 400 can be altered, e.g., by having acts added, removed, rearranged, combined performed concurrently, and/or having single acts split into multiple acts. At act 401, the sending device 301 displays a list of available content to a user (sometimes referred to as the sender). The list of available content may include an identification of a third party that operates a third party server.

At act 403, the sending device 301 receives an indication of selected content from the user. For example, the user may select a source of the dynamic content to include in a message that will be sent to one or more recipients via the messaging application executing on the sending device. As described above, the sender can select the source by selecting the source from a list of available content. Alternatively, the user may select the source by entering a smart tag that identifies the source.

At act 405, the sending device 301 displays a list of fields for the selected content. The fields displayed may be received from the third party server 302 or included as part of the messaging application at the time of installation.

At act 407, the sending device 301 receives selected parameters from the user. The parameters are associated with the fields for the dynamic content in the messaging application. For example, the user may type parameter information into the messaging application using a keyboard or other input device of the sender's computing device. Alternatively, the parameters may be selected from a menu of optional parameters displayed in the GUI of the messaging application.

At act 409, the sending device 301 sends a request that includes the selected parameters to the third party server 302. The sending device 301 uses the API associated with the third party server 302 to create a request with a format expected by the third party server 302. By way of example and not limitation, the request may be a JavaScript Object Notation (JSON) message. The API places the parameters received from the user into the request and controls a network interface of the sending device 301 to send the request to the third party server 302. For example, the API may include in the request a URL associated with the desired dynamic content.

At act 411, the sending device 301 receives the dynamic content from the third party server 302 via a network interface of the sending device 301. The dynamic content may include text, images, video or other content that may updated frequently. Examples of dynamic content are provided above.

At act 413, the sending device 301 displays the dynamic content to the user using a visual display of the sending device 301. For example, the dynamic content may be displayed inline within a draft text message being prepared by the sender. Alternatively, the dynamic content may be displayed in a message separate from the text message prepared by the sender or other screen of the messaging application. In some implementations, act 413 may not be necessary. An advantage of displaying the dynamic content to the sender is that it provides the sender with an opportunity to review the dynamic content before sending the message to the recipient 307.

At act 415, the sending device 301 receives confirmation from the user that the user desires to send the dynamic content to the recipient. For example, after reviewing the dynamic content displayed at act 413, the user may use the input device of the sending device 301 to provide an indication that the user desires the dynamic content to be sent to the recipient.

At act 417, the sending device 301 sends the message that includes the selected parameters to the receiving device 304. The message may include information in addition to the dynamic content. For example, the message may include a static text message, static image, or static video. Sending the message may include sending the message to messaging server 303 for temporary or permanent storage prior to the message being relayed to the receiving device 304.

The sending device 301 may send the message before, after or while the sending device is retrieving the dynamic content from the third party server. In some embodiments, acts 409, 411 and 413 are not performed and the sending device does not retrieve the dynamic content. Instead, the sending device simply sends the API parameters to the recipient's device after the parameters are input by the sender.

After act 417 there are a number of actions the sending device 301 can take that are not illustrated. For example, a copy of the message remains on the visual display of the sending device 301 after the message is sent, as is conventional in messaging applications. The dynamic content displayed in the message may be updated in response to one or more triggers. To update the dynamic content acts 409, 411 and 413 may be repeated. A first trigger may be the passage of a predetermined amount of time. For example, the sending device 301 may be configured to update the dynamic content every five minutes. A second trigger may be the user of the sending device 301 opening the conversation that includes the message in the messaging application. For example, the user may be reading a message in a different conversation and then switch back to the conversation that includes the message. This event may trigger the updating of the dynamic content. A third trigger may be the user manually indicating that the dynamic content should be updated. For example, the GUI of the messaging application may provide a menu that includes an item that the user of the sending device 301 can use to indicate the dynamic content should be updated.

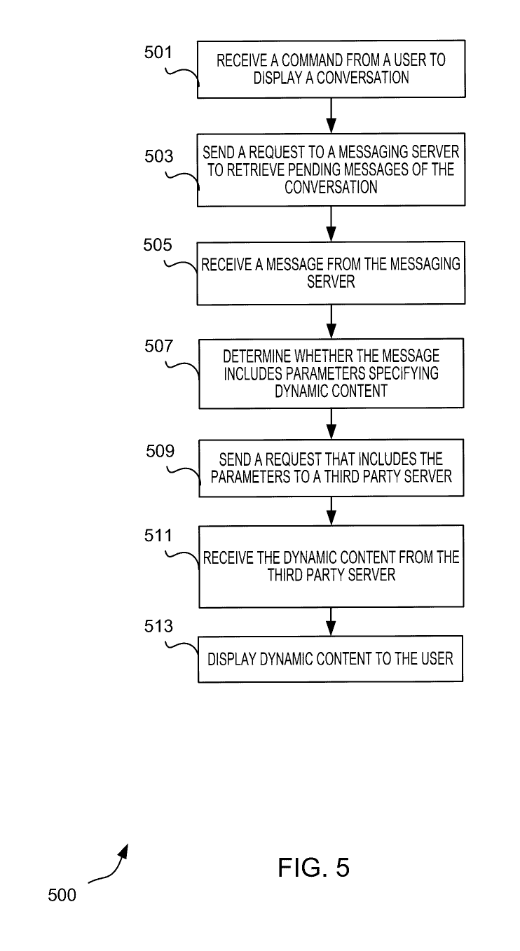

Referring to FIG. 5, a method 500 of operating the receiving device 304 includes the acts shown. The method 500 is, however, an example only and not limiting. The method 500 can be altered, e.g., by having acts added, removed, rearranged, combined performed concurrently, and/or having single acts split into multiple acts. shown. At act 501, the receiving device 304 receives a command from a user of the receiving device 304 (sometimes referred to as the recipient) to display a conversation within the messaging application. The recipient may, for example, select the conversation from a list of available conversations.

At act 503, the receiving device 304 sends a request to the messaging server 303 to retrieve pending messages of the conversation. A request is sent to the messaging server 303 to ensure the conversation is up to date. In addition to sending a request when a conversation is opened by the user of the receiving device 304, a similar request may be sent to update the conversation. For example, requests may be sent at regular intervals (e.g., every minute or five minutes) while the messaging application is active on the receiving device 304.

At act 505, the receiving device 304 receives the message from the messaging server. The message is the same message that the sending device 301 sent to the messaging server 303, as described in FIG. 4. The message includes the selected parameters that were included in the message by the sender, but does not include the dynamic content.

At act 507, the receiving device 304 determines whether the message includes parameters specifying dynamic content. Some messages may include only static content, such as conventional text messages or conventional multimedia messages. For static messages there is no need to contact the third party server 302 to retrieve the dynamic content. If it is determined that the message includes parameters specifying dynamic content, then the method 500 continues to act 509.

At act 509, the receiving device 304 sends a request that includes the parameters from the message to the third party server 302. This request is similar to the request sent by the sending device 301 at act 409 of FIG. 4. The receiving device 304 uses the API associated with the third party server 302 to create a request with a format expected by the third party server 302. By way of example and not limitation, the request may be a JavaScript Object Notation (JSON) message. The API places the parameters received from the user into the request and controls a network interface of the sending device 301 to send the request to the third party server 302. For example, the API may include in the request a URL associated with the desired dynamic content.

One of the parameters included in the message may include an identification of the third party server 302. This information allows the receiving device 304 to invoke the API associated with the third party server 302 and format the request as required by the third party server 302.

At act 511, the receiving device 304 receives the dynamic content from the third party server 302.

At act 513, the receiving device 304 displays the dynamic content to the user of the receiving device 304 via a visual display of the receiving device 304. In some implementations, the dynamic content may be shown in line with other content from the received message. For example, the message may include static text and the dynamic content may be text that is inserted into the static text. As an example, the message may include the static text: “My flight lands in Boston at,” and the messaging application of the receiving device 304 may place dynamic time information in line with the static text such that, when the message is displayed to the recipient, it states: “My flight lands in Boston at 7:40PM.”

The dynamic content, for example, may be displayed at a location in the message that was indicated by the sender when specifying the parameters of the dynamic content. Alternatively, the dynamic content may be displayed in a message separate from the text message or in some other way, which may be associated with the displayed message or which may be independent of the displayed message. For example, a separate notification may be displayed separate from the messages within in a particular conversation. Moreover, the specific format of display of the dynamic content may depend on the nature of the dynamic content. For example, if the dynamic content is a stream of data, the messaging application on the receiving user's device may display the dynamic content in ticker window overlaid on or next to a window displaying the message. In some embodiments, the dynamic content displayed on the sender's device and/or the recipient's device may be updated. The dynamic content is updated by sending additional API parameters to the third party server in an additional request. The dynamic content may be updated at a suitable time. For example, the dynamic content may be updated when the user requests that the dynamic content be updated. Alternatively or additionally, the dynamic content may be updated at periodic intervals. The interval may be set by the messaging application or the end user. For example, the message received from the sender may include an expected refresh frequency indicating how frequently the receiving device is expected to request updated content. Alternatively or additionally, the dynamic content may be updated every time a new action occurs within the conversation. For example, every time the user sends and/or receives a message, previously sent dynamic content may be updated. However, it should be appreciated that updates may be made in response to a suitable trigger.

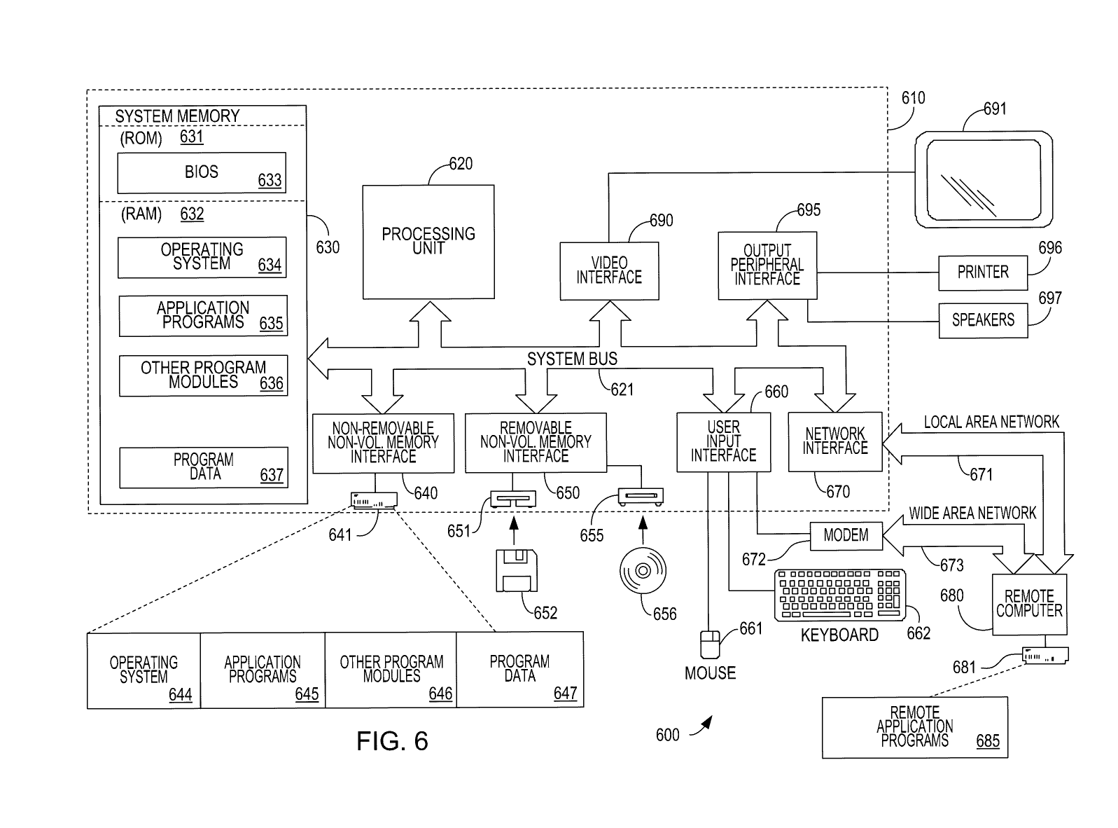

The computing devices 111-115 and the servers 130 and 140 illustrated in FIG. 1 may be implemented in any suitable combination of hardware and software. FIG. 6 illustrates an example of a suitable computing system environment 600 on which the computing devices 111-115 and the servers 130 and 140 may be implemented. The computing system environment 600 is only one example of a suitable computing environment and is not intended to suggest any limitation as to the scope of use or functionality of certain embodiments. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with certain embodiments include, but are not limited to, personal computers, server computers, hand-held or laptop devices, multiprocessor systems, microprocessor-based systems, set top boxes, smart watches, programmable consumer electronics, network PCs, minicomputers, automobiles, virtual reality systems, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. Certain embodiments may also be practiced in distributed computing environments where tasks are performed by remote processing devices that are linked through a communications network. In a distributed computing environment, program modules may be located in both local and remote computer storage media including memory storage devices.

With reference to FIG. 6, an example computer system for implementing one or more embodiments includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, embodiments may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects as discussed above. As used herein, the term “computer-readable storage medium” encompasses only a computer-readable medium that can be considered to be a manufacture (i.e., article of manufacture) or a machine.

The terms “program”, “application” or “software” are used herein in a generic sense to refer to any type of computer code or set of computer-executable instructions that can be employed to program a computer or other processor to implement various aspects discussed above. Additionally, it should be appreciated that according to one aspect of this embodiment, one or more computer programs that perform methods need not reside on a single computer or processor, but may be distributed in a modular fashion amongst a number of different computers or processors.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of embodiments may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, embodiments may include a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method of operating a sending device to send dynamic content to a receiving device, the method comprising:
determining a third party server based on input from a user;
sending a request to the third party server for the dynamic content, the request comprising at least one parameter associated with the dynamic content;
receiving the dynamic content from the third party server, the dynamic content being based on the at least one parameter;
displaying the dynamic content on a visual display of the sending device;
receiving an indication from the user of the sending device to send the dynamic content to the receiving device; and
sending a message to the receiving device, the message comprising the at least one parameter associated with the dynamic content, wherein the message does not include the dynamic content.

2. The method of claim 1, further comprising receiving an indication of the at least one parameter from the user of the sending device.

3. The method of claim 1, wherein sending the request and displaying the dynamic content is performed by a messaging application executing on the sending device.

4. The method of claim 1, wherein the message further comprises an expected refresh frequency indicating how frequently the receiving device is expected to request updated content.

5. The method of claim 1, wherein sending the message to the receiving device comprises sending the message to a messaging server that stores the message on behalf of the receiving device.

6. The method of claim 1, wherein the message further comprises plaintext to be displayed to a recipient of the message.

7. The method of claim 1, wherein the at least one parameter comprises an identification of the third party server based on the input from the user.

8. A non-transitory processor-readable storage medium comprising processor-readable instructions configured to cause a processor of a sending device to:
determine a third party server based on input from a user;
send a request to the third party server for dynamic content, the request comprising at least one parameter associated with the dynamic content;
receive the dynamic content from the third party server, the dynamic content being based on the at least one parameter;
display the dynamic content on a visual display of the sending device;
receive an indication from the user of the sending device to send the dynamic content to the receiving device; and
send a message to the receiving device, the message comprising the at least one parameter associated with the dynamic content, wherein the message does not include the dynamic content.

9. The non-transitory processor-readable storage medium of claim 8, wherein the instructions are further configured to cause the processor to receive an indication of the at least one parameter from the user of the sending device.

10. The non-transitory processor-readable storage medium of claim 8, wherein the instructions are a portion of a messaging application.

11. The non-transitory processor-readable storage medium of claim 8, wherein the message further comprises an expected refresh frequency indicating how frequently the receiving device is expected to request updated content.

12. The non-transitory processor-readable storage medium of claim 8, wherein the instructions are further configured to cause the processor to send the message to a messaging server that stores the message on behalf of the receiving device.

13. The non-transitory processor-readable storage medium of claim 8, wherein the message further comprises plaintext to be displayed to a recipient of the message.

14. The non-transitory processor-readable storage medium of claim 8, wherein the at least one parameter comprises an identification of the third party server based on the input from the user.

15. A sending device comprising:
a network interface configured to send and receive messages from a network;
a processor, communicatively coupled to the network interface, configured to:
determine a third party server based on input from a user;
send, via the network interface, a request to the third party server for dynamic content, the request comprising at least one parameter associated with the dynamic content;
receive, via the network interface, the dynamic content from the third party server, the dynamic content being based on the at least one parameter;
a visual display, communicatively coupled to the processor, configured to display the dynamic content; and
a user input device, communicatively coupled to the processor, configured to receive an indication from the user of the sending device to send the dynamic content to the receiving device;
wherein the processor is further configured to send a message to the receiving device, the message comprising the at least one parameter associated with the dynamic content, wherein the message does not include the dynamic content.

16. The sending device of claim 15, wherein the user input device is further configured to receive an indication of the at least one parameter from the user of the sending device.

17. The sending device of claim 15, wherein the processor is further configured to send the request and control the visual display to display the content by executing a messaging application.

18. The sending device of claim 15, wherein the message further comprises an expected refresh frequency indicating how frequently the receiving device is expected to request an updated content.

19. The sending device of claim 15, wherein to send the message to the receiving device the processor is further configured to send the message to a messaging server that stores the message on behalf of the receiving device.

20. The sending device of claim 15, wherein the message further comprises plaintext to be displayed to a recipient of the message.
